(19) United States
(12) Patent Application Publication
(10) Pub. No.: US 2003/0205429 A1
(43) Pub. Date: Nov. 6, 2003

(54) Sound-making devices and their use in animal control of damage to crops

(76) Inventor: Peretz Rosenberg, Doar Na Ha'amakim (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/411,123

(22) Filed: Apr. 11, 2003

(30) Foreign Application Priority Data
May 2, 2002 (IL) 149,449

(51) Int. Cl. G10K 7/00

(52) U.S. Cl. 181/143

(57) ABSTRACT

A sound-making device includes a hollow body closed at one end by an end wall and open at the opposite end; and a pulsator unit mounted centrally of the end wall; the pulsator unit having an inlet located externally of the hollow body for inletting a pressurized fluid in a continuous manner, and an outlet located within the hollow body for outletting the fluid in a pulsating manner effective to vibrate the end wall for generating sound waves. Also described is the use of such a device for protecting plants and ponds from birds or other animals.

### FIELD AND BACKGROUND OF THE INVENTION

The present invention relates to sound-making devices and to the use of such devices in animal control of damage to crops. The term crops is used herein in its broadest sense, to include, not only plants and fruit cultivated on the land and in orchards, but also fish cultivated in fish ponds.

Tremendous damage is caused by birds and other animals to various types of field crops or fruit trees, for example birds picking fruit growing on trees, grapes growing on vines, etc. Tremendous damage is also caused by birds eating fish from fish ponds. Various techniques have been used for minimizing such damage but the known techniques are generally not entirely satisfactory. For example, the use of scarecrows is of only very limited effectiveness; and the use of sound-generation techniques require an electrical installation which is generally relatively expense.

### OBJECTS AND BRIEF SUMMARY OF THE PRESENT INVENTION

An object of the present invention is to provide a sound-making device particularly useful in animal control of damage to crops, which device is both effective to scare-away the animals, and involves a relatively small installation and operation expense.

According to one aspect of the present invention, there is provided a sound-making device, comprising: a hollow body closed at one end by an end wall and open at the opposite end; and a pulsator unit mounted centrally of the end wall; the pulsator unit having an inlet located externally of the hollow body for inletting a pressurized fluid in a continuous manner, and an outlet located within the hollow body for outletting the fluid in a pulsating manner effective to vibrate the end wall for generating sound waves.

In the described preferred embodiment, the hollow body is constructed and dimensioned to produce a feedback resonance amplifying the intensity of the generated sound waves.

According to further features in the preferred embodiment of the invention described below, the hollow body is of a cylindrical configuration and is made of thin-wall metal.

More particularly in the described preferred embodiment, the pulsator unit includes: a housing defining an expansible-contractible chamber having the inlet at one side, and the outlet at the opposite side; and a membrane within the chamber such that in the contracted condition of the chamber, the membrane closes the outlet, and upon the expansion of the chamber, the membrane opens the outlet to produce a pulsatile water flow therethrough.

Particularly good results were obtained when the housing is of a bellows construction including a pair of circular plates secured together along their outer periphery, one of the plates being formed with the inlet and carrying the membrane, the other of the plates being formed with the outlet normally closed by the membrane in the contracted condition of the chamber, but open by the membrane upon the expansion of the chamber to produce the pulsatile water flow through the outlet.

For example, the pulsator device may be of the bellows-type construction described in my prior Israel Patent No. 121,380 (U.S. Pat. No. 6,026,851), or my pending Israel Patent Application No. 147,275, filed Dec. 24, 2001, mounted in the end wall of a metal can, such as used in canning beverages. Such a device can be produced in volume and at low cost and has been found to generate sound waves effective to scare-away birds and other animals from field plants as well as fish ponds.

According to another aspect of the present invention, therefore, there is provided a sound-making device comprising: a hollow body closed at one end by an end wall and open at the opposite end; and a bellows-type pulsatile unit mounted centrally of the end wall so as to be enclosed by the hollow body; the pulsatile unit having an inlet located externally of the hollow body for inletting pressurized water in a continuous manner, and an outlet located within the hollow body for outletting the water in a pulsating manner effective to vibrate the end wall for generating sound waves.

According to a further aspect of the invention, there is provided a method of preventing damage by animals to plants, comprising: locating at least one sound-making device as described above in the vicinity of the plants; and feeding water to the inlet in a continuous manner to produce a pulsating output effective to vibrate the hollow body for generating sound waves sufficient to scare-away the animals.

When such a sound-making device is used, the outlet of the pulsatile device may be used for irrigating the plants, thereby enabling such a system to perform the double-function of water irrigation and animal damage control.

According to another aspect of the invention, there is provided a method of preventing damage by birds to fish ponds, comprising: locating at least one sound-making device as described above in the vicinity of the fish pond; and feeding water to the inlet in a continuous manner to produce a pulsating output effective to generate sounds scaring-away the birds from the fish ponds.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one form of sound-making device constructed in accordance with the present invention;

FIG. 2 is an enlarged, fragmentary, sectional view particularly illustrating the pulsator unit in the device of FIG. 1;

FIG. 3 is an enlarged top view of the pulsator unit of FIG. 2;

FIG. 4 is an enlarged sectional view along line IV-IV of FIG. 3;

FIG. 5 is a side elevational view illustrating the stem and deformable membrane in the pulsator unit;

FIG. 6 is a sectional view along line VI-VI of FIG. 5;

FIG. 7 illustrates one application of the sound-making device for scaring-away birds and other animals from damaging fruit growing on the trees, and for using the water outletted from the sound-making device for irrigating the tree;

FIG. 8 illustrates a similar application as in FIG. 7, but wherein the water outletted from the sound-making device is directed to a water irrigation line, e.g., a dripper line, for irrigating trees or other crops; and

FIG. 9 illustrates another application of the sound-making device for scaring-away birds from fish ponds.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiment described is for purposes of example only, and that the invention is capable of being embodied in other forms and applications than described herein.

### DESCRIPTION OF A PREFERRED EMBODIMENT

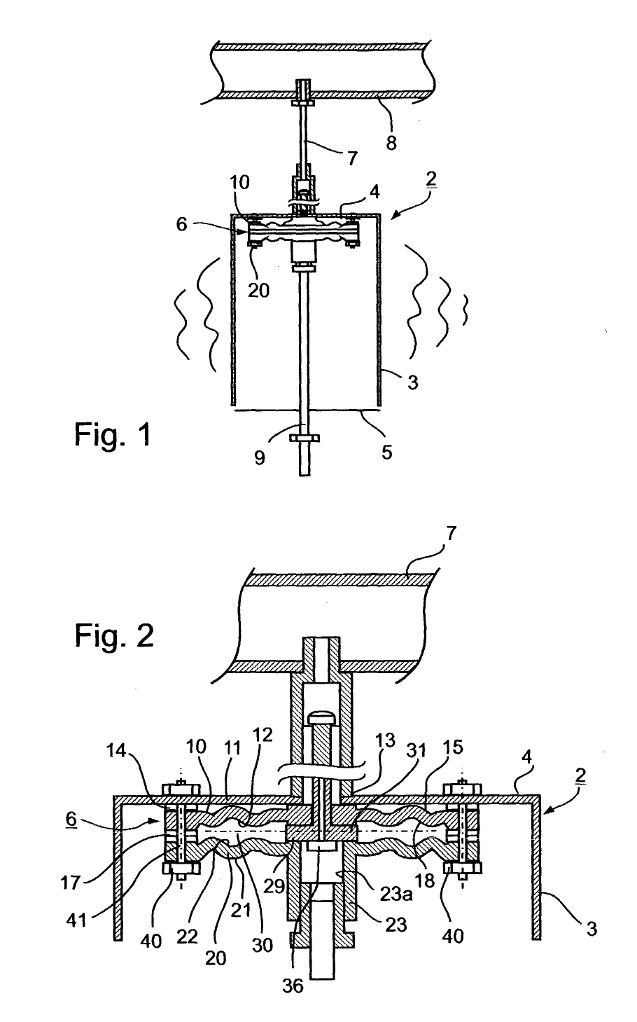

The sound-making device illustrated in FIG. 1 includes a hollow body, generally designated 2, having a cylindrical side wall 3, closed at one end by a circular end wall 4 and open at the opposite end 5. A preferred construction for such a hollow body would be a thin-wall metal can such as used for canning beverages. Such metal cans are available in large quantities at very low cost which makes them ideally suited for use in the sound-making device illustrated in FIG. 1.

Mounted within the metal can 2 is a pulsator unit, generally designated 6. A preferred construction of such a pulsator unit is that described in my U.S. Pat. No. 6,026,851 (Israel Patent No. 121,380) and in my Israel Patent Application No. 147,275, filed Dec. 24, 2001; the contents of the above patent and application are incorporated by reference herein.

Pulsator unit 6 is mounted centrally of end wall 4 of the metal can 2. Metal can 2, with the pulsator unit 6 mounted therein, is suspended by a flexible tube 7 connecting the inlet of the pulsator unit 6 to a water supply pipe 8. The outlet of pulsator unit 6 is connected to another flexible tube 9.

As will be described more particularly below, pressurized water is supplied in a continuous manner from the water supply pipe 8 to the inlet of the pulsator unit 6 and is outletted by the pulsator unit 6 in a pulsating manner to the flexible tube 9. The pulsations of the pulsator unit 6 are effective to vibrate the metal can 2 and to cause it to generate sound waves. Preferably metal can 2 is constructed and dimensioned to produce a feedback resonance amplifying the intensity of such generated sound waves.

The construction of pulsator unit 6 is more particularly illustrated in FIGS. 2-6.

It includes a housing constituted of two circular end plates or discs 10, 20, which are attached together and sealed around their otter peripheries such that they define a fluid chamber 30. Thus, circular plate 10 includes an outer face 11, an inner face 12, and an inlet in the form of a central connector sleeve 13 defining the inlet opening 13a (FIG. 4) for conducting the water into chamber 30. Circular plate 20 includes an outer face 21, an inner face 22, and an outlet in the form of a central connector sleeve 23 defining the outlet opening 23a for discharging the water from chamber 30.

The outer face 11 of circular plate 10 is formed with a flat outer margin 14 and a plurality of concentric recesses 15 decreasing in diameter inwardly from margin 14 towards the central sleeve 13. The inner face 12 of circular plate 10 is similarly formed with a flat outer margin 17 and with concentric circular recesses 18, which are aligned with the spaces between the concentric circular recesses 15 formed on the outer face 11.

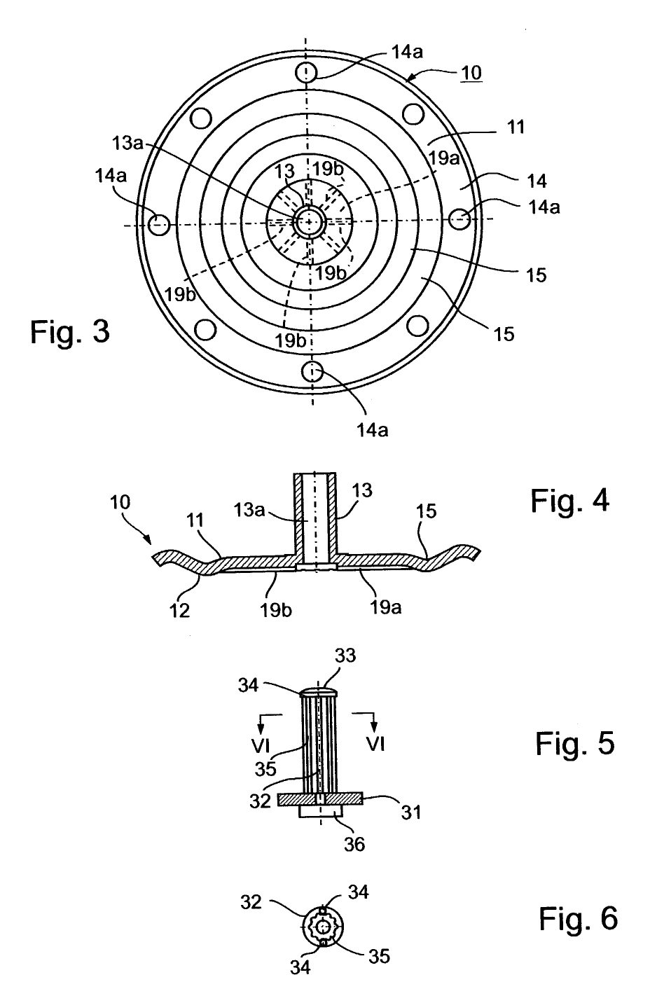

The outer face 11 of circular plate 10 is more particularly illustrated in FIGS. 3 and 4. Thus, its flat outer margin 14 is formed with a plurality of openings 14a for receiving the fasteners fastening it to plate 20, as will be described more particularly below. It further includes a central circular recess 19a around the inlet opening 13a defined by the inlet connector sleeve 13, and a plurality of radially-extending recesses 19b radiating outwardly from the circular recess 19a.

Circular plate 20 is of similar construction, except that its central region circumscribing outlet opening 23a of the outlet connector sleeve 23 is flat, as shown at 29, and is not formed with recesses corresponding to circular recesses 19a and radial recesses 19b in circular plate 10.

It will thus be seen that circular plate 20, constitutes a wall formed with the outlet opening 23a, is displaceable away from circular plate 10, constituting a wall formed with inlet opening 13a, upon an increase in the pressure of the water within chamber 30.

The flat inner surface 29 of end plate 20 serves as a valve seat in cooperation with a deformable membrane 31 located within chamber 30 for controlling the flow of the water from that chamber via the outlet opening 23a. As shown particularly in FIG. 5, deformable membrane 31 is carried at the inner end of a stem 32 passing through the inlet opening 13a. Stem 32 is formed with enlarged head 33 having a plurality of spaced projections 34 on its inner surface engageable with the end of the inlet connector sleeve 13 so as to provide a flow passageway therefrom into the space between stem 32 and the inlet connector sleeve. Stem 32 is further formed with a plurality of axially-extending recesses 35 to conduct the water to the circular recess 19a on the inner face of end plate 10, and via the radial recesses 19b underlying the inner face of deformable membrane 31 into chamber 30.

Deformable membrane 31 is secured to the inner end of stem 32 by a fastener 36 passing through the center of the membrane. Thus, the center of membrane 31 is fixed to stem 32, but the outer periphery of the membrane is free to deform according to the differential pressure applied to the opposite faces of the membrane, as will be described more particularly below.

The two circular plates 10, 20 are secured together, and to end wall 4 of the metal can 2, by plurality of fasteners 40 passing through the flat outer peripheries 14, 24 of the two plates. A sealing ring 41 is interposed between the two plates to seal the chamber 30 defined by them. Although the two end plates 10, 20 are each made of substantially rigid plastic material, the concentric-recesses formed in their inner and outer faces permit their center regions to be displaced outwardly, and thereby to expand chamber 30 as the pressure within the chamber increases.

The axial recesses 35 in stem 32, and the recesses 19a, 19b in the inner face of end plate 10 covered by deformable membrane 31, define a reduced-flow passageway from the water supply pipe 8 into chamber 30 permitting a relatively low rate of continuous water flow via the inlet opening 13a into the chamber. This low inflow rate is substantially lower than the outflow rate permitted through the outlet opening 23a when deformable membrane opens the outlet opening, as will be described more particularly below.

### Operation

The sound-making device illustrated in FIGS. 1-6 operates as follows:

Whenever the water in supply pipe 8 is turned on (e.g., by a suitable control valve, not shown), a continuous flow of pressurized water is supplied via the pipe to the inlet of the inlet 13 of the pulsator unit 6. Membrane 31 is normally pressed against the flat inner surface 29 of circular plate 20 of the pulsator unit 6, so that the water starts to fill chamber 30 and to cause the chamber to expand. However, since the outer face of membrane 31 is vented to the atmosphere via the outlet opening 23a, the build-up pressure within chamber 30 firmly presses the outer periphery of the membrane against the inner surface 29 of plate 20, thereby maintaining the outlet opening closed, but causing the membrane to deform to a concave configuration.

As the pressure within chamber 30 builds up, outlet opening 23a of circular plate 20 is displaced further, until its displacement exceeds the deformability of membrane 31, whereupon the outer periphery of the membrane separates from the inner surface of circular plate 20 to open the outlet opening 23a. This produces a rapid discharge of a small quantity of the water from chamber 30, which thereby also releases the pressure within chamber 30 to enable circular plate 20 to quickly return to its normal, unstressed condition reclosing the valve.

The cycle is then repeated, thereby producing a pulsatile water flow from the outlet 23 of the pulsator unit 6 to the outlet tube 9.

It is to be understood that the expression “pulsatile water flow” is used herein in its broadest sense, to include not only an interrupted water flow wherein the pulsations are distinct pulses separated by interruptions in the water flow (as in a conventional pulsator system), but also a continuous water flow wherein the pulsations are modulations or ripples in the continuous water flow. In either case, these pulsations produce a vibration of the pulsator unit 6, and of the end wall 4 of the metal can 2 to which the pulsator unit is attached.

Preferably, the flow rate into the pulsator unit 6 via the water supply pipe 8 is within the range of 20-150 liters/hour; and the pressure of the water is within the range of 2-5 Bars. Preferably, the metal can 2 is within the range of 8-15 cm in length, and 4-10 cm in diameter. Metal cans for canning soft drinks and other beverages of about 11-12 cm in length and 6-7 cm in diameter have been found particularly effective in generating intense, high frequency sounds by the pulsations of the pulsator unit 6. When constructing a sound-making device of the foregoing dimensions, it has been found that the pulsater unit 6 produces pulsations of 40-100 vibrations per second, and that a feedback resonance is produced greatly amplifying the intensity of the generated sound waves sufficient to scare away birds and other animals.

### EXAMPLES OF APPLICATIONS

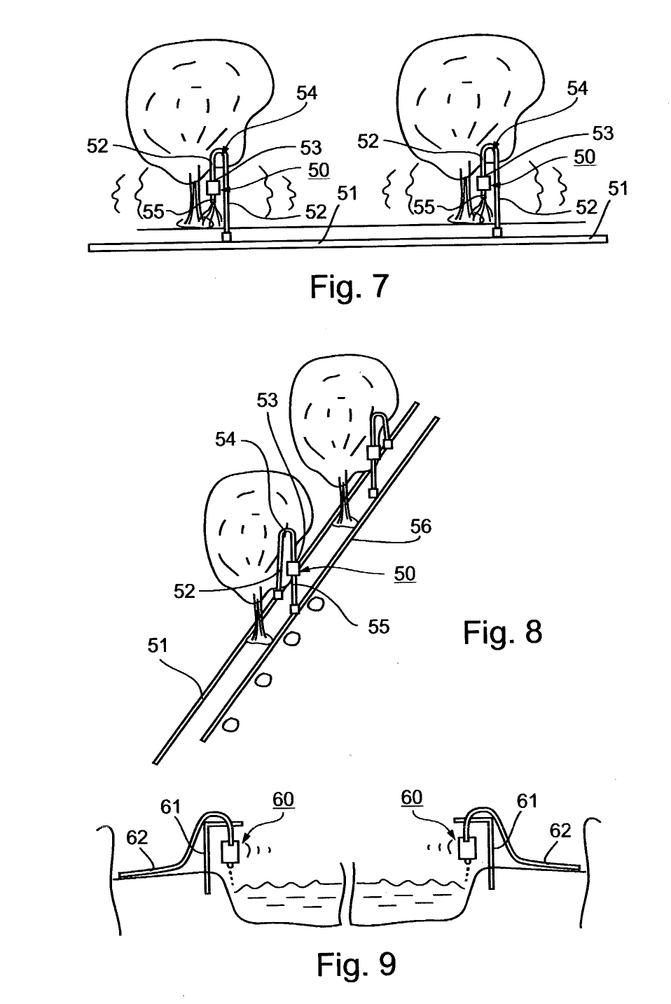

FIG. 7 illustrates an example of one application of sound-making device constructed as described above with respect to FIGS. 1-6. In this example, the sound generating device, therein generally designated 50, is supplied by water from a water supply pipe 51 connected by a flexible tube 52 to the inlet 53 of the pulsator unit (not shown, but corresponding to pulsator unit 6 in FIG. 1) within the metal can of the sound-making device 50. The sound-making device 50 may be conveniently suspended from a branch 54 of the tree whose fruit is to be protected from birds or other animals. The outlet of the pulsator unit within the sound-making device 50 is connected to a flexible outlet tube 55 such that the pulsatile water flow outletted from the pulsator unit is used for irrigating the tree.

It will thus be seen that whenever it is desired to scare-away birds or other animals from picking at fruit in the tree, the water supply pipe 51 is turned on to cause the pulsator unit (6, FIG. 1) within the sound-making device 50 to vibrate rapidly, generating sound waves, which sound waves are amplified in intensity by the metal can 50 in the manner described above. It will also be appreciated that the water used for generating the sound waves is not wasted, but rather is used for irrigating the tree.

Since the sound-making device 50 in FIG. 7 is suspended from a branch of the tree by flexible tube 52, the intense vibrations produced by the pulsator unit will also cause the sound-making device 50 to flap around as it generates and amplifies the sound waves. In addition, since the outlet tube 55 is also flexible, it will also flap around as the sound waves are generated by the sound producing device 50. These movements of the sound producing device 50 and of the outlet tube 55 also contribute to scaring-away the birds or other animals.

FIG. 8 illustrates an application similar to that of FIG. 7: the corresponding parts are therefore identified by the same reference numerals to facilitate understanding. In FIG. 8, however, the outlet from the pulsator unit within the sound-making device 50 is fed to a water irrigation line 56, such as a drip line, for use in irrigating the same trees being protected by the sound-making device, or for irrigating other crops.

FIG. 9 illustrates another application of the sound-producing device described above, namely for scaring-away birds flying over fish ponds and eating fish being cultivated within the ponds. In this application, one or more of the sound-producing devices, generally designated 60 in FIG. 9, are supported in suspension over the pond, e.g., by stakes 61 (or by floats) and are actuated by supplying pressurized water from a water supply tube to the pulsator units within these devices, in the manner described above, to generate intense sounds having the effect of scaring-away the birds.

The sound-making devices described above can be used in many other applications. For example, they can be used for scaring-away birds over landing fields, which represents a significant hazard in aircraft take-off or landing strips. They can also be used for scaring-away pigeons or other birds from congregating or nesting in areas where they tend to constitute a nuisance or cause actual damage. They can also be used to scare-away various types of animals from chicken houses, pens, or other animal enclosures. The fact that the use of such a device requires only a water supply and no electrical supply, and the further fact that such device can be constructed of a relatively few simple parts which can be produced in volume and at low cost, enable such devices to be used in a multitude of other possible applications.

It will be appreciated, therefore, that while the invention has been described above with respect to one preferred embodiment, and examples of several applications of such an embodiment, these are set forth merely for purposes of example, and that many other variations, modifications and applications of the invention may be made.

What is claimed is:

1. A sound-making device, comprising:
a hollow body closed at one end by an end wall and open at the opposite end;
and a pulsator unit mounted centrally of said end wall;
said pulsator unit having an inlet located externally of said hollow body for inletting a pressurized fluid in a continuous manner, and an outlet located within said hollow body for outletting said fluid in a pulsating manner effective to vibrate said end wall for generating sound waves.

2. The sound-making device according to claim 1, wherein said hollow body is constructed and dimensioned to produce a feedback resonance amplifying the intensity of said generated sound waves.

3. The sound-making device according to claim 1, wherein said hollow body is of cylindrical configuration.

4. The sound-making device according to claim 1, wherein said hollow body is made of a thin-wall metal.

5. The sound-making device according to claim 1, wherein said pulsator unit includes:
a housing defining an expansible-contractible chamber having said inlet at one side, and said outlet at the opposite side;
and a membrane within said chamber such that in the contracted condition of the chamber, the membrane closes said outlet, and upon the expansion of said chamber, said membrane opens said outlet to produce a pulsatile water flow therethrough.

6. The sound-making device according to claim 5, wherein said housing is of a bellows construction including a pair of circular plates secured together along their outer periphery, one of said plates being formed with said inlet and carrying said membrane, the other of said plates being formed with said outlet normally closed by said membrane in the contracted condition of the chamber, but open by said membrane upon the expansion of said chamber to produce said pulsatile water flow through said outlet.

7. The sound-making device according to claim 1, wherein said fluid inlet is connected to a pressurized water source supplying water to the inlet of the pulsator unit at a rate of 20-150 liters/hour.

8. The sound-making device according to claim 7, wherein said pressurized water source supplies water to the inlet of the pulsator unit at a pressure of 2-5 Bars.

9. The sound-making device according to claim 1, wherein said inlet is connected to a flexible tube serving to suspend said hollow body and to permit the hollow body to flap around as it generates said sound waves.

10. The sound-making device according to claim 1, wherein said outlet is connected to a flexible tube hanging freely from the outlet such that it flaps around as the hollow body generates said sound waves.

11. A sound-making device, comprising:
a hollow body closed at one end by an end wall and open at the opposite end;
and a bellows-type pulsatile unit mounted centrally of said end wall so as to be enclosed by said hollow body;
said pulsatile unit having an inlet located externally of said hollow body for inletting pressurized water in a continuous manner, and an outlet located within said hollow body for outletting said water in a pulsating manner effective to vibrate said end wall for generating sound waves.

12. The sound-making device according to claim 11, wherein said hollow body is of cylindrical configuration.

13. The sound-making device according to claim 11, wherein said hollow body is made of a thin-wall metal.

14. The sound-making device according to claim 11, wherein said fluid inlet is connected to a pressurized water source supplying water to the inlet of the pulsator unit at a rate of 20-150 liters/hour.

15. The sound-making device according to claim 11, wherein said pressurized water source supplies water to the inlet of the pulsator unit at a pressure of 2-5 Bars.

16. The sound-making device according to claim 11, wherein said inlet is connected to a flexible tube serving to suspend said hollow body and to permit the hollow body to flap around as said sound waves are generated.

17. The sound-making device according to claim 11, wherein said outlet is connected to a flexible tube hanging freely from the outlet such that it flaps around as the hollow body generates said sound waves.

18. The sound-making device according to claim 1, wherein said hollow body is a thin-wall metal can having a length of 8-15 cm and a diameter of 4-10 cm.

19. The sound-making device according to claim 17, wherein said metal can has a length of 11-12 cm and a diameter of 6-7 cm.

20. A method of preventing damage by protecting plants, or ponds from animals comprising:
locating at least one sound-making device according to claim 1, in the vicinity of the plants or ponds; and feeding water to said inlet in a continuous manner to produce a pulsating output effective to vibrate the hollow body for generating sound waves sufficient to scare-away said animals.
